(19) United States
(12) Patent Application Publication
(10) Pub. No.: US 2008/0148641 A1
(43) Pub. Date: Jun. 26, 2008

(54) Rotary Actuator

(75) Inventors: Cristian Furlanetto, Nervesa della Battaglia (IT); Lorenzo Galberti, Musile di Piave (IT)

Correspondence Address: KATTEN MUCHIN ROSENMAN LLP, 575 MADISON AVENUE, NEW YORK, NY, 10022-2585, US

(73) Assignee: NICE SPA, Treviso (IT)

(21) Appl. No.: 11/949,847

(22) Filed: Dec. 4, 2007

(30) Foreign Application Priority Data
Dec. 22, 2006 (IT) TV2006A000233

(51) Int. Cl. E05F 3/00

(52) U.S. Cl. 49/358; 49/506

(57) ABSTRACT

Rotary actuator (10) for gates, door leaves or the like, which can be fixed to a stable structure (30) and comprises a rotating arm (18) pivotably mounted between two support parts (20, 16). The actuator comprises, on each support part, means (80) for performing fixing to the stable structure.

The invention relates to a rotary actuator, in particular for moving door leaves or shutters.

In the art many rotary actuators, used for example to cause the rotation of leaves or shutters of gates, sliding doors, hatches, and also robot components, are known. Here reference will be made by way of example to the former. Usually these actuators are formed by an electric motor and a mechanical arm (or a bracket) which is kinematically connected to the motor shaft. The arm is connected during installation of the actuator to the leaf or shutter which may therefore rotate, being pushed or driven so as to move by the arm.

An example is described in the document U.S. Pat. No. 5,102,377. This describes an actuator with a rotating movable arm which operates a gate. The movable arm is arranged between two retaining parts: a fixing arm and a closing end. The arm support structure is such that the forces acting on the movable arm are transmitted to both the retaining parts, but only the fixing arm offers a fixed restraining resistance. This asymmetrical structure requires careful and precise designing so as to be able to withstand an external stress applied to the movable arm, as, for example, during installation, the forced opening of the gate causes a power failure or an impact. If the stress is very great, as not infrequently happens, the entire retaining structure of the movable arm may be deformed, with serious consequences for correct operation of the actuator (in particular its gears). For this reason, the various components must be designed with extra-large dimensions, also resulting in a considerable increase in the cost of the product. Since the fixing arm is fixed to a wall or to a column at one point, this point becomes the fulcrum of a favourable lever force which has as its arm the fixing arm, such that the latter may be pulled out of its seat.

The object of the invention is to provide an actuator of the type described, which withstands better the external stresses acting on the movable arm.

This object is achieved with a rotary actuator for gates, door leaves or the like, which can be fixed to a stable structure and comprises a rotating arm pivotably mounted between two support parts, characterized in that it comprises, on each support part, means for performing fixing to the stable structure.

In this way the external forces acting on the actuator arm are transmitted to the stable structure in a symmetrical manner and without unfavourable lever forces. Each twisting movement of the movable arm moreover encounters resistance at two fixed points at least, namely the points where each support part is fixed to the stable structure. Advantageously the support parts may have a substantially identical form and dimensions and/or internal structure so that (i) they may be easily manufactured and the actuator is simplified, (ii) they constitute an optimum system for balancing the forces acting on the actuator, transmitting them in an equal and/or symmetrical manner to the fixing means, (iii) the rotatable connection to the movable arm is simplified and/or standardized, for example by means of the provision internally of mating flanges and coaxial seats for a pivot pin. The invention also relates to a method for fixing to a stable structure a rotary actuator for gates, door leaves or the like, comprising a rotating arm pivotably mounted between two support parts, characterized in fixing each support part to the stable structure.

The advantages of a device according to an invention will nevertheless emerge more clearly from the following description of a preferred embodiment which refers to the accompanying drawing in which:

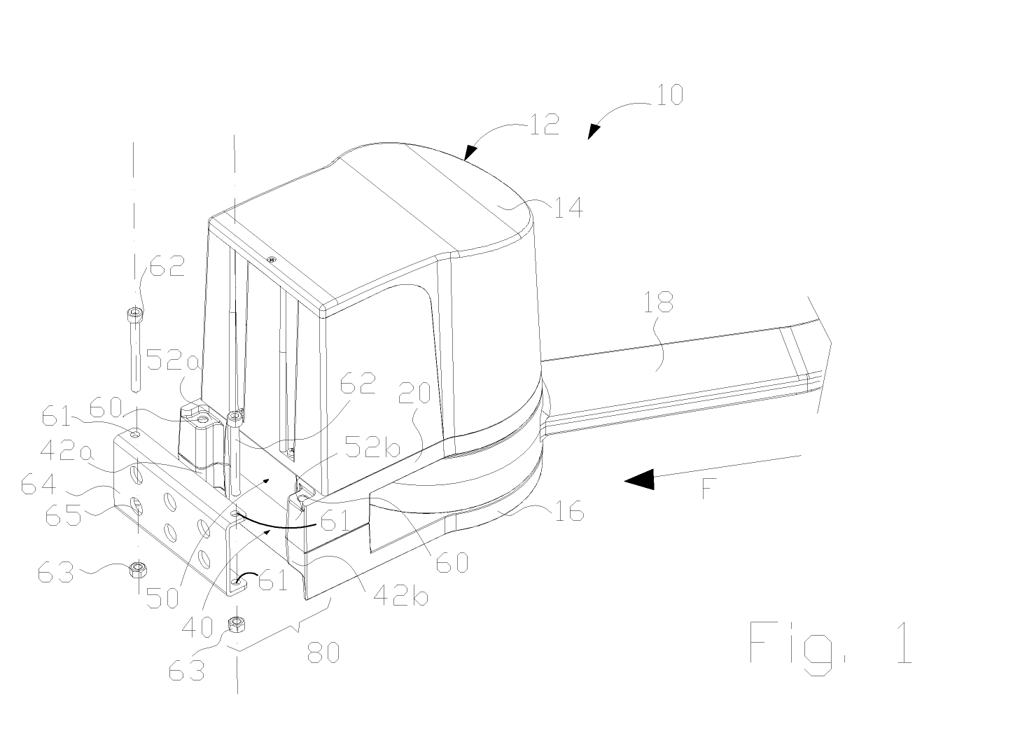

FIG. 1 shows a perspective view, with some parts separated, of an actuator according to the invention;

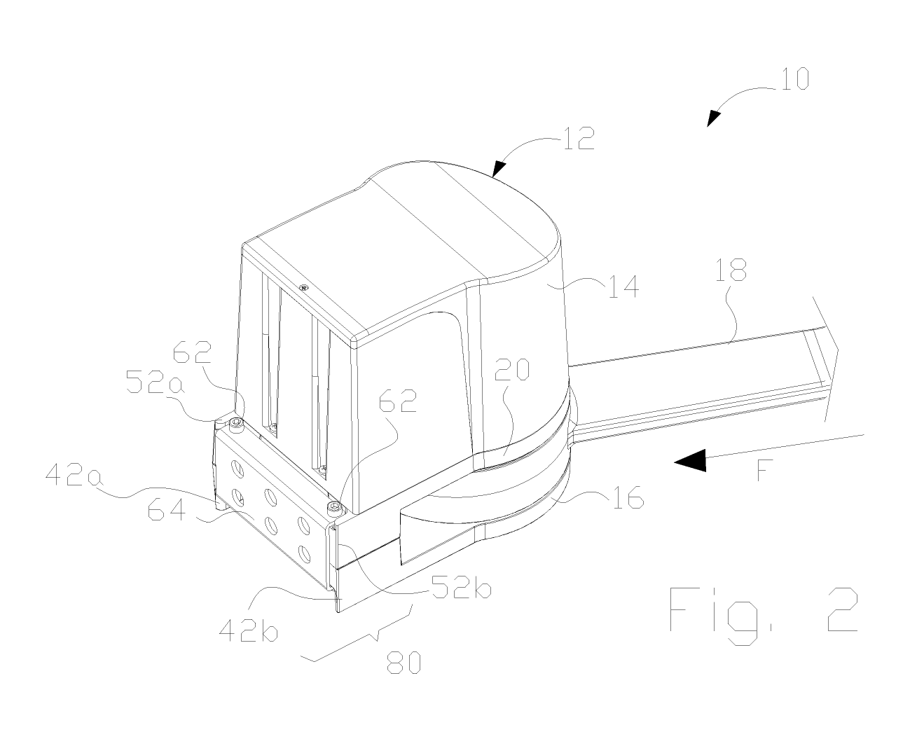

FIG. 2 shows the actuator according to FIG. 1 with all the parts assembled;

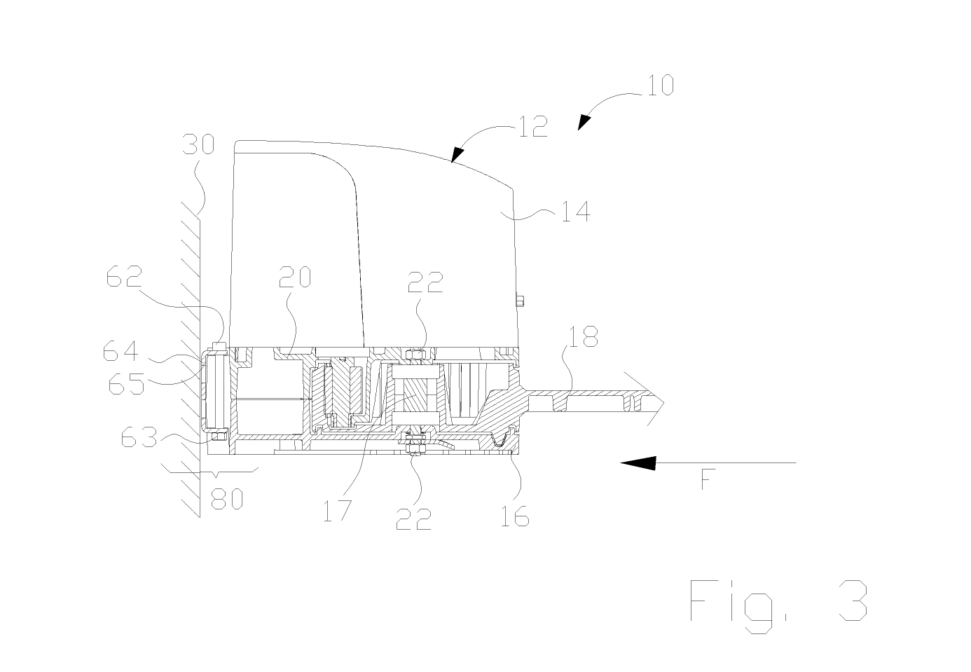

FIG. 3 shows a cross-sectional view of the actuator according to FIG. 1 along a vertical symmetrical plane.

The figures show a rotary actuator 10 according to the invention. It comprises an enclosure 12 formed by an upper housing 14 and two flat support parts—a plate 20 at the base of the housing 14 and bottom 16—between which an arm 18 rotating in a horizontal plane (partly shown) is pivotably mounted by means of a pin 17, said arm in turn being connected to a gate leaf (not visible) so as to cause the movement thereof. From FIG. 3 it can be noted how the pin 17 is fixed rotatably by means of nuts 22 inside the plate 20 and the bottom 16. Other gear-type mechanical members—for the sake of simplicity not described—have the task of imparting to the arm 18 the necessary moment so as to rotate it about the pin 17. The actuator 10 can be fixed to a stable structure, for example a wall 30, by means of fixing means 80 comprising flanged ends 40, 50 of the two support parts 16, 20. These flanged ends 40, 50 consist of two lugs 42a, 42b and 52a, 52b projecting at the rear respectively from the body of each support part 16, 20. The lugs 42a, 42b, 52a, 52b, being extensions of the respective support part 16, 20, have practically the same thickness as them and have through-holes 60 which extend perpendicularly with respect to the larger dimension of the support parts 16, 20, namely vertically with reference to the Figures. Respective fixing screws 62 can be inserted in the holes 60 and engage in holes 61 of a C-shaped plate 64 which is secured to the stable structure 30 for example by means of bolts (not shown) which are retained inside holes 65 in the plate 64. The screws 62, which have nuts 63 at their opposite ends, are arranged so as to fix the lugs 42a, 42b, 52a, 52b inside the plate 64, between its two curved ends. FIGS. 1 and 2 show the actuator 10 before and after joining to the plate 64 and tightening of the screws 62. FIG. 3 shows the actuator 10 mounted on the structure 30.

The advantage of the invention is thus evident: a force F acting on the arm 18 (see FIG. 3) directed against the actuator 10 is transmitted by means of the pin 17 onto the two support parts 16, 20 which transmit it equally onto the plate 64 and from here to the structure 30. In view of the symmetry of the parts involved, the force F does not produce twisting on the pin 17 nor on the structure of the actuator 10. Moreover the fixing means 80 are stressed thereby in the direction of greatest resistance and again without transverse forces or twisting. If an external twisting force is imparted to the arm 18, axially with respect to the arrow F, this twisting force is opposed by the two support parts 16, 20 secured to the stable structure 30 and its maximum value which can be withstood by the actuator 10 is determined by the strength of the means 80 and by the resistance to deformation of the parts 16, 20. It can be understood how the actuator 10 is therefore very robust and may withstand forces F also of a very intense nature (for example during an attempt at forced manual opening by unauthorised personnel).

As can be seen in particular from FIGS. 2 and 3, the support parts 16, 20 have a form and internal structure which is practically identical and a mirror image with respect to the plane of mutual contact. In this way the following advantages are obtained:

the structure of the actuator 10 is simplified;

automatically the flanged ends 40, 50, in particular the lugs 42a, 42b, 52a, 52b, are arranged so that the through-holes 60 are aligned, thus reducing the number of screws 62 required;

the symmetry of the flanged ends 40, 50 facilitates connection to the plate 64, simplifying also the design of the latter;

the structure of the actuator 10 is more balanced and suitable for withstanding the stresses at play;

the support parts 16, 20 are designed more precisely and simply with a significant reduction in the production costs.

Clearly variants are possible, for example:

in the arrangement and form of the flanged ends;

in the number and arrangement of the through-holes (and therefore the fixing screws);

in the form of the securing plates, which is in any case optional since the flanged ends 40, 50 could for example be screwed directly to the structure 30;

in the fixing means, which may also comprise adhesives, joint connections or simply, for example, grooves and holes inside which a bracket integral with the stable structure is inserted or fixed. In this latter case it is of fundamental importance, however, to envisage on each support part at least one point for securing to the stable structure.

1. Rotary actuator (10) for gates, door leaves or the like, which can be fixed to a stable structure (30) and comprises a rotating arm (18) pivotably mounted between two support parts (20, 16), characterized in that it comprises, on each support part, means (80) for performing fixing to the stable structure.

2. Rotary actuator (10) according to claim 1, in which the fixing means comprise flanged ends (42a, 42b, 52a, 52b) of the support parts (16, 20).

3. Rotary actuator (10) according to claim 2, in which the flanged ends consist of lugs (42a, 42b, 52a, 52b) projecting from the body of the support part.

4. Rotary actuator (10) according to claim 2, in which the flanged ends have through-holes (60) inside which respective screws (60) for performing fixing to a plate (64) for securing to the stable structure (30) can be inserted.

5. Rotary actuator (10) according to claim 4, in which the flanged ends (42a, 42b, 52a, 52b) of each support part (16, 20) are arranged so that the through-holes (60) are aligned.

6. Rotary actuator (10) according to claim 4, in which the through-holes (60) extend perpendicularly with respect to the greater dimension of the support parts (16, 20).

7. Rotary actuator (10) according to claim 1, in which the support parts (16, 20) have a substantially identical structure.

8. Method for fixing to a stable structure (30) a rotary actuator for gates, door leaves or the like, comprising a rotating arm (18) pivotably mounted between two support parts (20, 16), characterized in fixing each support part to the stable structure.
